(19) United States
(12) Patent Application Publication
(10) Pub. No.: US 2007/0033565 A1
(43) Pub. Date: Feb. 8, 2007

(54) Basic cell of semiconductor integrated circuit and layout method thereof

(76) Inventors: Takashi Ohyabu, Osaka (JP); Hiroto Yamaguchi, Osaka (JP); Atsushi Takahashi, Osaka (JP)

Correspondence Address: MCDERMOTT WILL & EMERY LLP, 600 13TH STREET, N.W., WASHINGTON, DC, 20005-3096, US

(21) Appl. No.: 11/497,243

(22) Filed: Aug. 2, 2006

(30) Foreign Application Priority Data
Aug. 2, 2005 (JP) 2005-224090

(51) Int. Cl. G06F 17/50

(52) U.S. Cl. 716/17

(57) ABSTRACT

Basic cells each including, in addition to logic cells, one or a plurality of capacity cells between a power supply line and a ground line, and the like, are prepared in advance in the form of a logic synthesis cell library. The prepared basic cells are inserted at a logic synthesis step or layout designing step such that a uniform voltage drop suppression effect is obtained.

### BACKGROUND OF THE INVENTION

The present invention relates to a method for reducing a voltage drop due to low voltage driving, long and large wirings, simultaneous switching of transistors (hereinafter, referred to as “IR-DROP” or simply “DROP”) in a semiconductor integrated circuit.

In recent years, in a miniaturization process which accompanies a process shrink, IR-DROP phenomenon frequently occurs wherein the proportion of a voltage drop with respect to the supply voltage in an LSI internal circuit increases due to an increase of the wire resistance which results from long and large wirings, a decrease in supply voltage, an increase in circuit scale, simultaneous switching of transistors because of synchronous design, and an increase in power consumption which results from high speed operation, and as a result, an error operation occurs due to a timing variation caused by the voltage drop.

A conventional solution to this problem is a capacitance connected to a pattern of supply lines and ground lines over a substrate in a layout for which arrangement and wiring of cells have been completed through a layout step for a semiconductor integrated circuit.

However, conventionally, capacity cells are supposed to be connected to supply and ground lines after a layout is generated. In this case, a capacitance cannot be provided at a place of a large power variation which constitutes a cause of power supply noise without a modification to the layout.

To solve this problem, Japanese Laid-Open Patent Publication No. 2001-351985 proposes a layout method wherein elements, such as transistors, which have large power supply variations are detected before generation of a layout of a semiconductor integrated circuit, and capacitances are added to the power-supplies of the elements, such that power supply noise components are efficiently absorbed; and a layout method wherein a capacity cell is incorporated in a cell itself which is a source of noise, whereby a capacity cell is surely located at a source of noise.

However, the conventional capacity cell arrangement methods require the step of extracting a circuit having N or more fanouts before generation of a layout or the step of determining the number of signal state variations within a predetermined time interval based on a test pattern and extracting an element which has undergone a larger number of variations than a predetermined number of variations, resulting in a complicated algorithm and complicated design flow.

### SUMMARY OF THE INVENTION

To solve the above problems, according to the present invention, a basic cell including a logic cell and one or a plurality of capacity cells or a basic cell including a plurality of logic cells which are not connected to each other is prepared in advance.

According to the present invention, a capacity cell included in a basic cell or the capacitance of an incorporated logic cell which is not connected to a certain logic cell functions as a bypass capacitor. In the case of a voltage drop, the bypass capacitor provides a discharging effect, and in the case of a voltage rise, the bypass capacitor provides a charging effect, such that a transient voltage is averaged. Thus, the bypass capacitor can be located with the minimum distance from a basic cell in which DROP needs to be suppressed. Therefore, a voltage variation due to DROP can be reduced.

### BRIEF DESCRIPTION OF THE DRAWINGS

FIG. 1 shows a layout of a basic cell according to embodiment 1 of the present invention.

FIG. 2 shows a layout of a basic cell according to embodiment 2 of the present invention.

FIG. 3 shows a layout of a basic cell according to embodiment 3 of the present invention.

FIG. 4 shows a layout of a basic cell according to embodiment 4 of the present invention.

FIG. 5 shows a layout of a basic cell according to embodiment 5 of the present invention.

FIG. 6 shows a layout of a basic cell according to embodiment 6 of the present invention.

FIG. 7 shows a layout of a basic cell according to embodiment 7 of the present invention.

FIG. 8 shows a layout of a basic cell according to embodiment 8 of the present invention.

FIG. 9 shows a layout of a basic cell according to embodiment 9 of the present invention.

FIG. 10 shows a layout of a basic cell according to embodiment 10 of the present invention.

FIG. 11 shows a layout of a basic cell according to embodiment 11 of the present invention.

FIG. 12 shows a layout of a basic cell according to embodiment 12 of the present invention.

FIG. 13 shows a layout of a basic cell according to embodiment 13 of the present invention.

FIG. 14 is a flowchart illustrating a method for designing a semiconductor integrated circuit using the basic cells of FIG. 1 through FIG. 13.

FIG. 15A and FIG. 15B show basic cell arrangements representing a result of arrangement after CTS insertion and a result of averaging of basic cell numbers, respectively, in the flow of FIG. 14.

FIG. 16 is a flowchart illustrating a variation of the example of FIG. 14.

### DESCRIPTION OF THE PREFERRED EMBODIMENTS

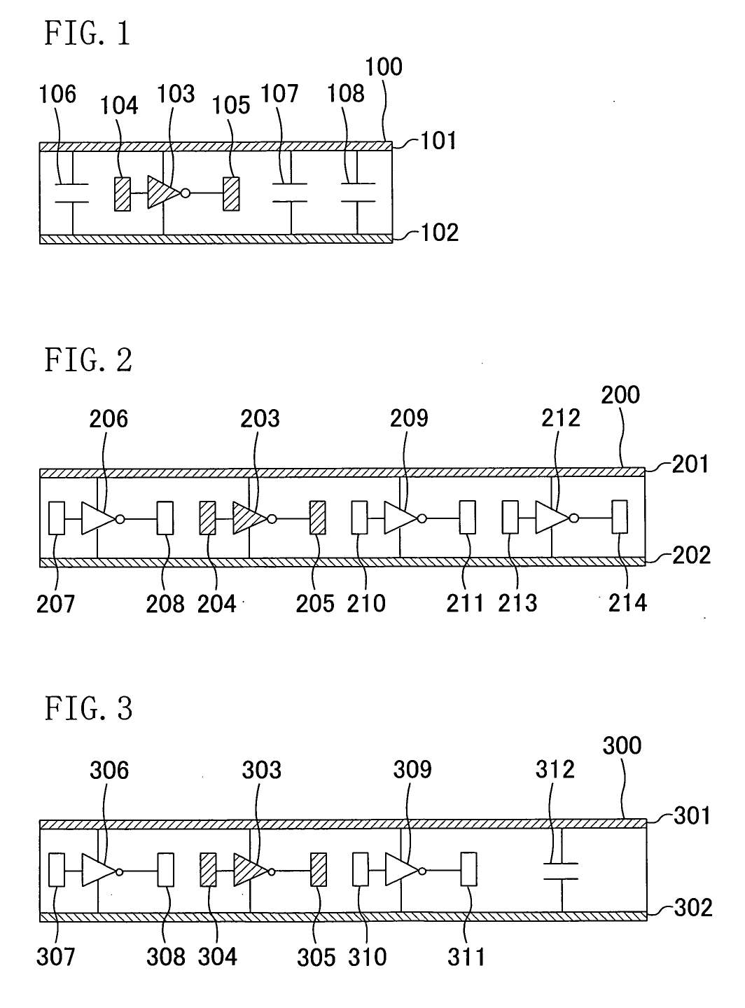

Basic cells according to embodiments of the present invention will be described with reference to FIG. 1 through FIG. 13.

FIG. 1 shows a layout of a basic cell according to embodiment 1 of the present invention. The basic cell 100 shown in FIG. 1 includes a power supply line 101, a ground line 102, a logic cell 103, an input terminal 104 of the logic cell 103, an output terminal 105 of the logic cell 103, and capacity cells 106, 107 and 108 which are connected to the power supply line 101 and the ground line 102.

The cell layout of FIG. 1 has the capacity cells 106, 107 and 108 between the power supply line 101 and the ground line 102 which are connected to the logic cell 103. The capacity cells 106, 107 and 108 are located adjacently at both left and right sides of the logic cell 103 to function as bypass capacitors. Specifically, in the case of a voltage drop, the bypass capacitors provide a discharging effect, and in the case of a voltage rise, the bypass capacitors provide a charging effect, such that a transient voltage is averaged. Thus, a bypass capacitor can be located with the minimum distance from a basic cell in which DROP needs to be suppressed. Therefore, a voltage variation due to DROP can be reduced.

FIG. 2 shows a layout of a basic cell according to embodiment 2 of the present invention. The basic cell 200 shown in FIG. 2 includes a power supply line 201, a ground line 202, a logic cell 203, an input terminal 204 of the logic cell 203, an output terminal 205 of the logic cell 203, a logic cell 206, an input terminal 207 of the logic cell 206, an output terminal 208 of the logic cell 206, a logic cell 209, an input terminal 210 of the logic cell 209, an output terminal 211 of the logic cell 209, a logic cell 212, an input terminal 213 of the logic cell 212, and an output terminal 214 of the logic cell 212.

In FIG. 2, the logic cells 206, 209 and 212, which are not connected to one another, are located adjacently at both left and right sides of the logic cell 203. The capacitances of these logic cells serve as bypass capacitors. Specifically, in the case of a voltage drop, the bypass capacitors provide a discharging effect, and in the case of a voltage rise, the bypass capacitors provide a charging effect, such that a transient voltage is averaged. Thus, a bypass capacitor can be located with the minimum distance from a basic cell in which DROP needs to be suppressed. Therefore, a voltage variation due to DROP can be reduced.

Further, the logic cells 206, 209 and 212 can be used as repair cells. Therefore, a timing variation due to change of function can be suppressed to a minimum level.

FIG. 3 shows a layout of a basic cell according to embodiment 3 of the present invention. The basic cell 300 shown in FIG. 3 includes a power supply line 301, a ground line 302, a logic cell 303, an input terminal 304 of the logic cell 303, an output terminal 305 of the logic cell 303, a logic cell 306, an input terminal 307 of the logic cell 306, an output terminal 308 of the logic cell 306, a logic cell 309, an input terminal 310 of the logic cell 309, an output terminal 311 of the logic cell 309, and a capacity cell 312 which is connected to the power supply line 301 and the ground line 302.

In FIG. 3, the logic cells 306 and 309, which are not connected to each other, are located adjacently at both left and right sides of the logic cell 303, and the capacity cell 312 is provided between the power supply line 301 and the ground line 302. These elements serve as bypass capacitors. Specifically, in the case of a voltage drop, the bypass capacitors provide a discharging effect, and in the case of a voltage rise, the bypass capacitors provide a charging effect, such that a transient voltage is averaged. Thus, a bypass capacitor can be located with the minimum distance from a basic cell in which DROP needs to be suppressed. Therefore, a voltage variation due to DROP can be reduced.

Further, the logic cells 306 and 309 can be used as repair cells. Therefore, a timing variation due to change of function can be suppressed to a minimum level.

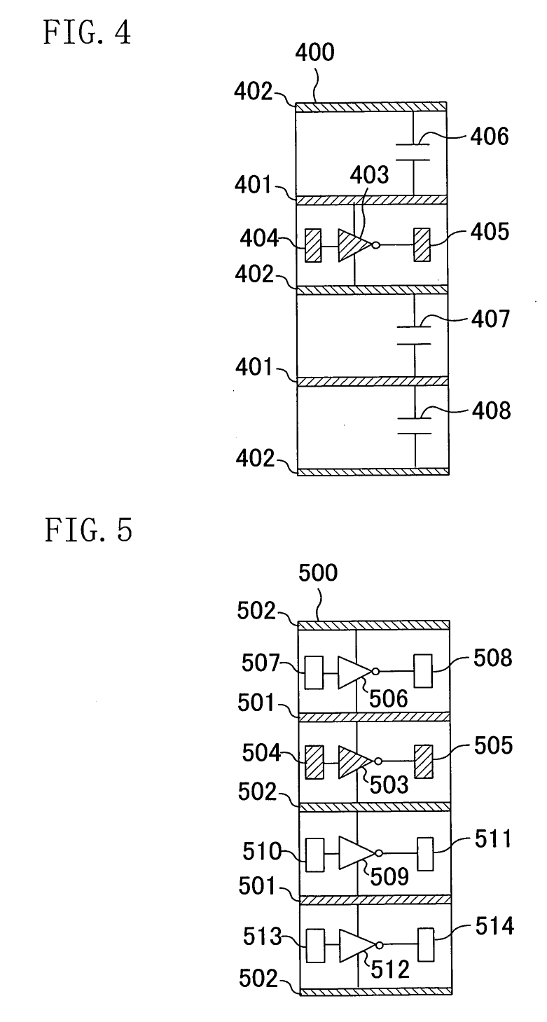

FIG. 4 shows a layout of a basic cell according to embodiment 4 of the present invention. The basic cell 400 shown in FIG. 4 includes a power supply line 401, a ground line 402, a logic cell 403, an input terminal 404 of the logic cell 403, an output terminal 405 of the logic cell 403, and capacity cells 406, 407 and 408 which are connected to the power supply line 401 and the ground line 402.

In FIG. 4, the capacity cells 406, 407 and 408 are provided between the power supply line 401 and the ground line 402 which are connected to the logic cell 403. The capacity cells 406, 407 and 408 are located adjacently at both upper and lower sides of the logic cell 403 to function as bypass capacitors. Specifically, in the case of a voltage drop, the bypass capacitors provide a discharging effect, and in the case of a voltage rise, the bypass capacitors provide a charging effect, such that a transient voltage is averaged. Thus, a bypass capacitor can be located with the minimum distance from a basic cell in which DROP needs to be suppressed. Therefore, a voltage variation due to DROP can be reduced.

FIG. 5 shows a layout of a basic cell according to embodiment 5 of the present invention. The basic cell 500 shown in FIG. 5 includes a power supply line 501, a ground line 502, a logic cell 503, an input terminal 504 of the logic cell 503, an output terminal 505 of the logic cell 503, a logic cell 506, an input terminal 507 of the logic cell 506, an output terminal 508 of the logic cell 506, a logic cell 509, an input terminal 510 of the logic cell 509, an output terminal 511 of the logic cell 509, a logic cell 512, an input terminal 513 of the logic cell 512, and an output terminal 514 of the logic cell 512.

In FIG. 5, the logic cells 506, 509 and 512 are located adjacently at both upper and lower sides of the logic cell 503. The capacitances of these logic cells serve as bypass capacitors. Specifically, in the case of a voltage drop, the capacitances provide a discharging effect, and in the case of a voltage rise, the capacitances provide a charging effect, such that a transient voltage is averaged. Thus, a bypass capacitor can be located with the minimum distance from a basic cell in which DROP needs to be suppressed. Therefore, a voltage variation due to DROP can be reduced.

Further, the logic cells 506, 509 and 512 can be used as repair cells. Therefore, a timing variation due to change of function can be suppressed to a minimum level.

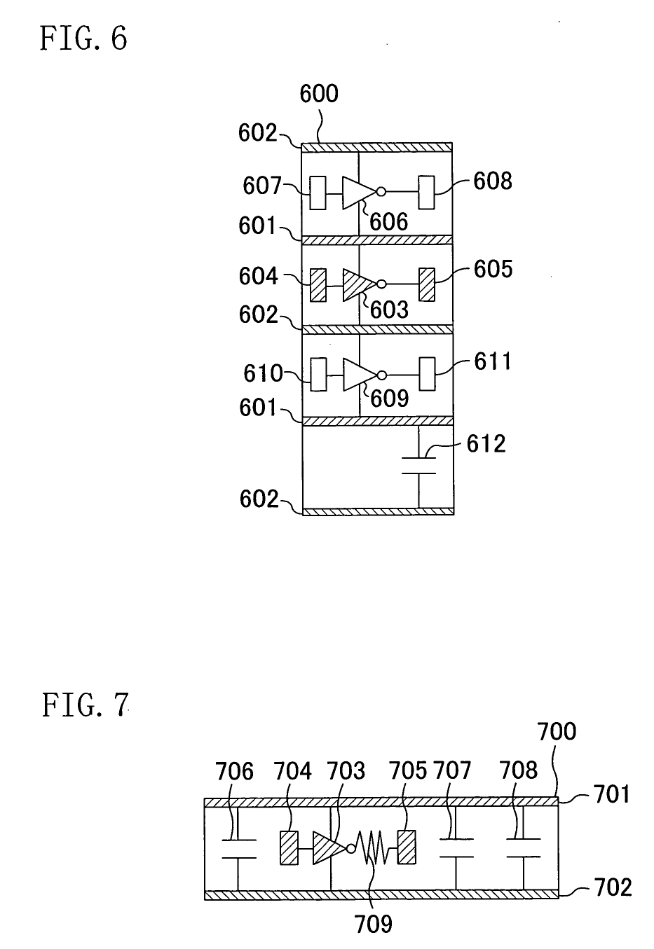

FIG. 6 shows a layout of a basic cell according to embodiment 6 of the present invention. The basic cell 600 shown in FIG. 6 includes a power supply line 601, a ground line 602, a logic cell 603, an input terminal 604 of the logic cell 603, an output terminal 605 of the logic cell 603, a logic cell 606, an input terminal 607 of the logic cell 606, an output terminal 608 of the logic cell 606, a logic cell 609, an input terminal 610 of the logic cell 609, an output terminal 611 of the logic cell 609, and a capacity cell 612 which is connected to the power supply line 601 and the ground line 602.

In FIG. 6, the logic cells 606 and 609 are located adjacently at both upper and lower sides of the logic cell 603, and the capacity cell 612 is provided between the power supply line 601 and the ground line 602. These elements serve as bypass capacitors. Specifically, in the case of a voltage drop, the bypass capacitors provide a discharging effect, and in the case of a voltage rise, the bypass capacitors provide a charging effect, such that a transient voltage is averaged. Thus, a bypass capacitor can be located with the minimum distance from a basic cell in which DROP needs to be suppressed. Therefore, a voltage variation due to DROP can be reduced.

Further, the logic cells 606 and 609 can be used as repair cells. Therefore, a timing variation due to change of function can be suppressed to a minimum level.

FIG. 7 shows a layout of a basic cell according to embodiment 7 of the present invention. The basic cell 700 shown in FIG. 7 includes a power supply line 701, a ground line 702, a logic cell 703, an input terminal 704 of the logic cell 703, an output terminal 705 of the logic cell 703, capacity cells 706, 707 and 708 which are connected to the power supply line 701 and the ground line 702, and a resistive cell 709 which is present on an output signal line of the logic cell 703.

In FIG. 7, the resistive cell 709 is provided on the output signal line of the logic cell 703. With this structure, the resistive cell 709 connected to the output signal line and parasitic capacitance function as a low-pass filter for an output signal. Therefore, the power supply bounce and ground bounce due to a transient voltage variation which occurs at the time of simultaneous switching with other logic cells can be reduced.

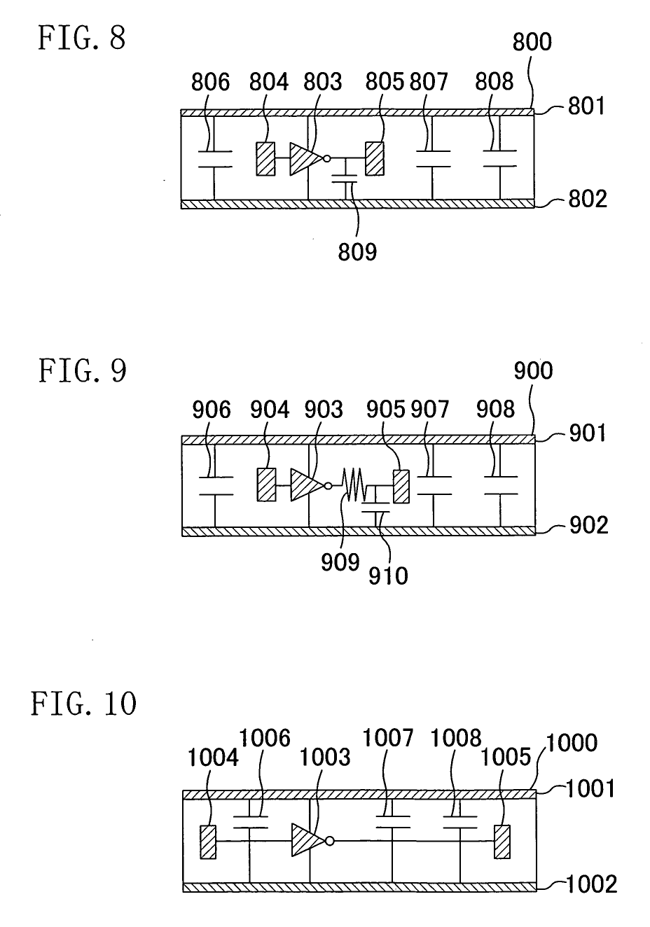

FIG. 8 shows a layout of a basic cell according to embodiment 8 of the present invention. The basic cell 800 shown in FIG. 8 includes a power supply line 801, a ground line 802, a logic cell 803, an input terminal 804 of the logic cell 803, an output terminal 805 of the logic cell 803, capacity cells 806, 807 and 808 which are connected to the power supply line 801 and the ground line 802, and a capacity cell 809 which is present between an output signal line of the logic cell 803 and the ground line 802.

In FIG. 8, the capacity cell 809 provided between the output signal line of the logic cell 803 and the ground line 802 and the resistance of the output signal line function as a low-pass filter for an output signal. Therefore, the power supply bounce and ground bounce due to a transient voltage variation which occurs at the time of simultaneous switching of logic cells can be reduced.

FIG. 9 shows a layout of a basic cell according to embodiment 9 of the present invention. The basic cell 900 shown in FIG. 9 includes a power supply line 901, a ground line 902, a logic cell 903, an input terminal 904 of the logic cell 903, an output terminal 905 of the logic cell 903, capacity cells 906, 907 and 908 which are connected to the power supply line 901 and the ground line 902, a resistive cell 909 which is present on an output signal line of the logic cell 903, and a capacity cell 910 which is present between the output signal line of the logic cell 903 and the ground line 902.

In FIG. 9, the resistive cell 909 provided on the output signal line of the logic cell 903 and the capacity cell 910 provided between the output signal line of the logic cell 903 and the ground line 902 function as a low-pass filter for an output signal. Therefore, the power supply bounce and ground bounce due to a transient voltage variation which occurs at the time of simultaneous switching of logic cells can be reduced.

FIG. 10 shows a layout of a basic cell according to embodiment 10 of the present invention. The basic cell 1000 shown in FIG. 10 includes a power supply line 1001, a ground line 1002, a logic cell 1003, an input terminal 1004 of the logic cell 1003, an output terminal 1005 of the logic cell 1003, and capacity cells 1006, 1007 and 1008 which are connected to the power supply line 1001 and the ground line 1002.

In FIG. 10, the positions of input and output terminals of the logic cell 1003 are different from those of the logic cell 103 shown in FIG. 1. Therefore, the convergence of wires can be improved by selecting basic cells having an optimum arrangement of input and output terminals in view of the wiring congestion.

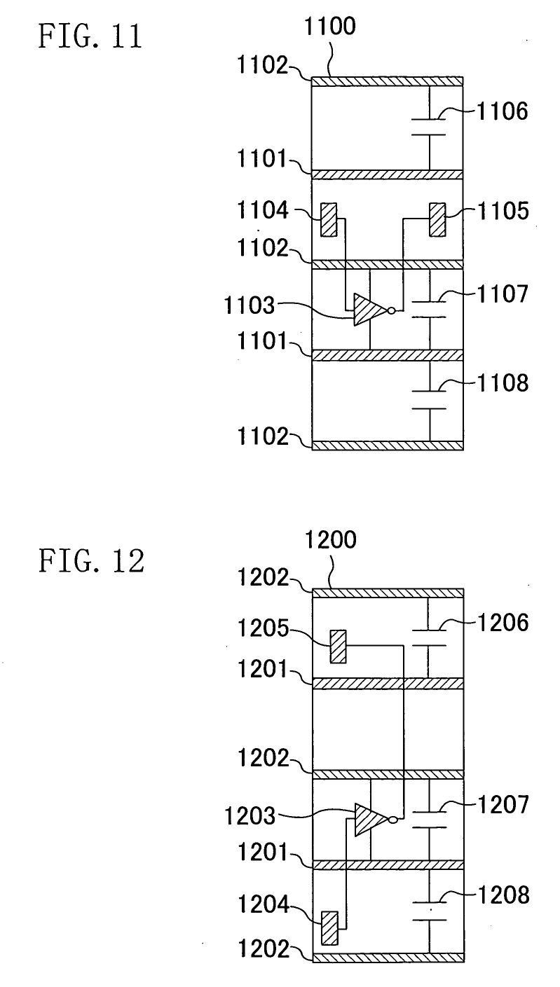

FIG. 11 shows a layout of a basic cell according to embodiment 11 of the present invention. The basic cell 1100 shown in FIG. 11 includes a power supply line 1101, a ground line 1102, a logic cell 1103, an input terminal 1104 of the logic cell 1103, an output terminal 1105 of the logic cell 1103, and capacity cells 1106, 1107 and 1108 which are connected to the power supply line 1101 and the ground line 1102.

In FIG. 11, the position of the logic cell 1103 is different from that of the logic cell 403 shown in FIG. 4. Therefore, the voltage variation due to DROP can be reduced by selecting basic cells having an optimum logic cell arrangement in view of DROP.

FIG. 12 shows a layout of a basic cell according to embodiment 12 of the present invention. The basic cell 1200 shown in FIG. 12 includes a power supply line 1201, a ground line 1202, a logic cell 1203, an input terminal 1204 of the logic cell 1203, an output terminal 1205 of the logic cell 1203, and capacity cells 1206, 1207 and 1208 which are connected to the power supply line 1201 and the ground line 1202.

In FIG. 12, the position of the logic cell 1203 is different from that of the logic cell 403 shown in FIG. 4, and the positions of the input terminal 1204 and the output terminal 1205 are different from those of the input terminal 404 and the output terminal 405 shown in FIG. 4. Therefore, improvement in the convergence of wires and reduction in the voltage variation due to DROP can be realized by selecting basic cells having an optimum arrangement of input and output terminals in view of the wiring congestion and an optimum logic cell arrangement in view of DROP.

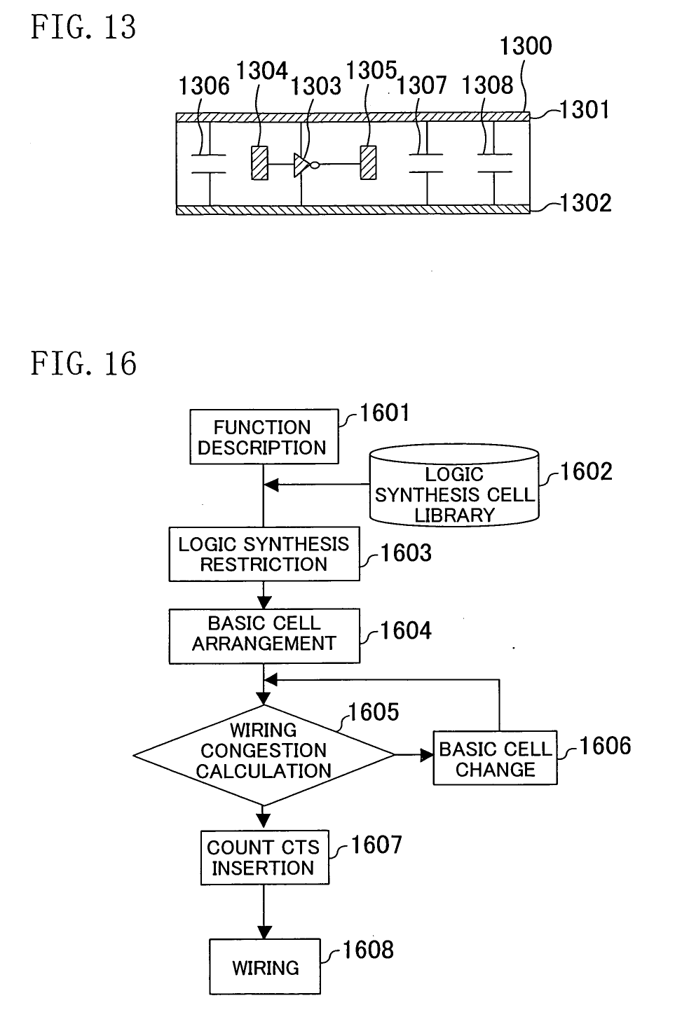

FIG. 13 shows a layout of a basic cell according to embodiment 13 of the present invention. The basic cell 1300 shown in FIG. 13 includes a power supply line 1301, a ground line 1302, a logic cell 1303, an input terminal 1304 of the logic cell 1303, an output terminal 1305 of the logic cell 1303, and capacity cells 1306, 1307 and 1308 which are connected to the power supply line 1301 and the ground line 1302.

In FIG. 13, the logic cell 1303 has the same cell size and the same input and output terminal positions as those of the logic cell 103 shown in FIG. 1 but has a different driving capacity from that of the logic cell 103. Therefore, it is possible to change the basic cell to a basic cell conformable to the DROP amount without rearrangement/rewiring.

It should be noted that, in FIG. 7 to FIG. 13, the capacity cells connected between the power supply line and the ground line can be logic cells which are not connected to one another. In this case, these cells can be used as repair cells.

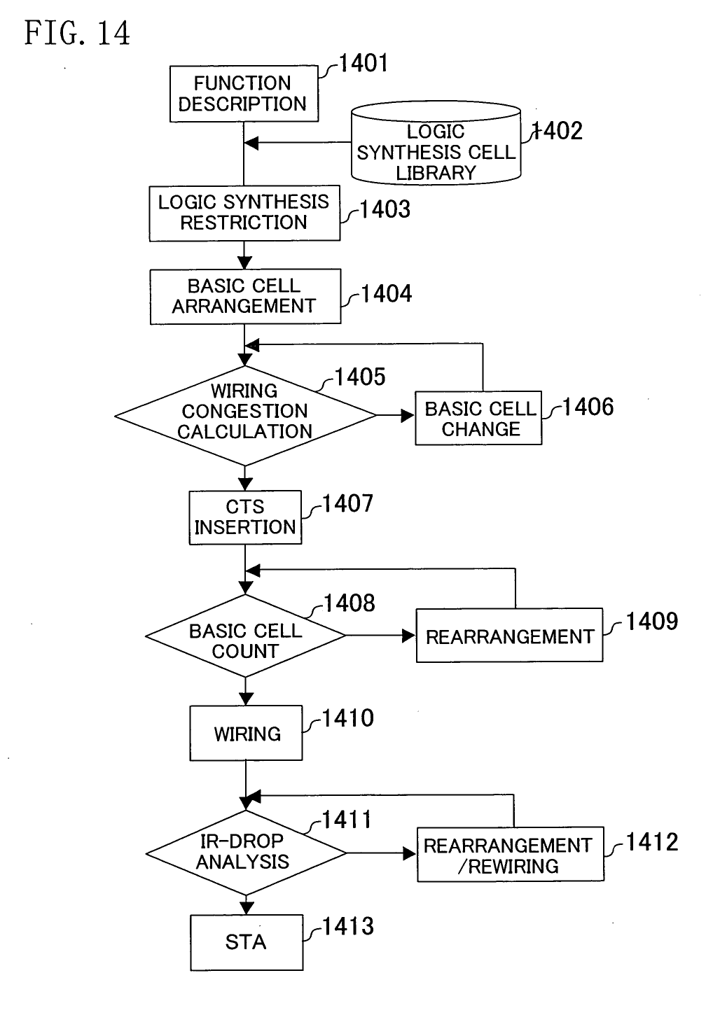

Next, a method for designing a semiconductor integrated circuit using the basic cells of FIG. 1 to FIG. 13 is described with reference to FIG. 14 to FIG. 16.

FIG. 14 is a design flowchart of a semiconductor integrated circuit according to the present invention. The flowchart includes function description 1401, a logic synthesis cell library 1402, logic synthesis restriction 1403, a basic cell arrangement process 1404, a wiring congestion calculating process 1405, a basic cell changing process 1406, a CTS inserting process 1407, a basic cell count process 1408, a basic cell rearranging process 1409, a wiring process 1410, an IR-DROP analysis 1411, a rearrangement/rewiring process 1412, and a STA process 1413.

In FIG. 14, normal basic cells and the basic cells of FIG. 1 to FIG. 13 are registered in advance in the form of the logic synthesis cell library 1402. At the step of the function description 1401, a clock generation module and the like are described as blocks. At the step of the logic synthesis restriction 1403, the basic cells of FIG. 1 to FIG. 13 are designated to perform logic synthesis, whereby a layout netlist is generated. Further, at the step of the logic synthesis restriction 1403, logic synthesis is performed with prohibition against the use of normal basic cells to generate a layout netlist. In a logic synthesis process for generating a layout netlist in such a manner, the basic cells of FIG. 1 to FIG. 13 are prepared in advance in the form of the logic synthesis cell library 1402. Therefore, in the logic synthesis step and layout arrangement step, a basic cell which reduces the voltage variation due to DROP can be selected in advance.

The layout netlist is arranged in the basic cell arrangement process 1404 in consideration of connectivity and timing. From a result of the basic cell arrangement, the wiring congestion is calculated in the wiring congestion calculating process 1405. In the basic cell changing process 1406, the basic cell is changed to the basic cell of FIG. 10 or FIG. 12 which has different input and output terminal positions according to the wiring congestion. Thus, the convergence of wires can be improved. In the CTS inserting process 1407, fan-out restriction and skew adjustment are carried out on the state of arrangement of flip flops (FF) after the change of basic cells.

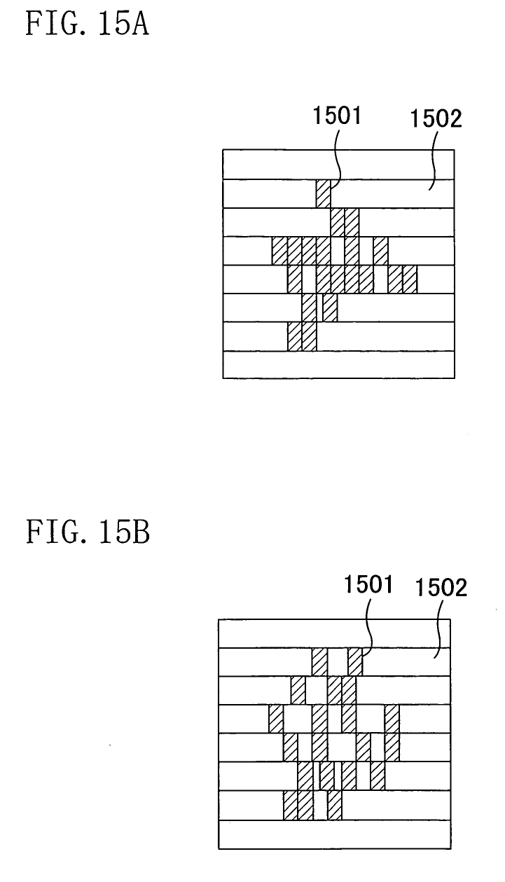

FIG. 15A shows a basic cell arrangement which represents a result of arrangement after CTS insertion. In FIG. 15A, reference numeral 1501 denotes the basic cells of FIG. 1 to FIG. 13, and reference numeral 1502 denotes a row of basic cells. In the basic cell count process 1408, the number of basic cells of FIG. 1 to FIG. 13 is counted for each row in which the power supply to the basic cells is equal. In the basic cell rearranging process 1409, the number of basic cells of FIG. 1 to FIG. 13 for each basic cell row is averaged as illustrated in FIG. 15B. In the wiring process 1410, wiring is carried out. As a result, a local DROP can be reduced.

After the arrangement and wiring process, the IR-DROP analysis 1411 is carried out. If a basic cell having a large DROP amount is extracted, the extracted basic cell is changed to a basic cell having large capacitance or small driving capacity which is selected from the basic cells of FIG. 1 to FIG. 13. Wiring is then performed in the basic cell rearrangement/rewiring process 1412, and a timing analysis is performed in the STA process 1413. As a result, a capacity cell can be placed in the vicinity of a clock line which needs a countermeasure for DROP in advance.

FIG. 16 shows a variation of the example of FIG. 14. The flowchart of FIG. 16 includes function description 1601, a logic synthesis cell library 1602, logic synthesis restriction 1603, a basic cell arrangement process 1604, a wiring congestion calculating process 1605, a basic cell changing process 1606, a count CTS inserting process 1607, and a wiring process 1608.

In FIG. 16, in the count CTS inserting process 1607 for basic cells, the number of basic cells of FIG. 1 to FIG. 13 in each basic cell row which is counted after the arrangement of basic cells in the basic cell arrangement process 1604 is considered. In the CTS insertion of the basic cells of FIG. 1 to FIG. 13, the number of basic cells is averaged for arrangement of the basic cells. With this, an optimum arrangement for addition of CTS buffers which is carried out after the arrangement of basic cells is realized. As a result, a local DROP can be reduced without performing rearrangement/rewiring processes.

It should be noted that although in FIG. 1 to FIG. 13 the logic cells in the basic cells are shown as inverters for simplicity of illustration, these elements can represent general logic cells, such as buffers, ANDs, ORs, FFs, etc.

Although FIG. 2 and FIG. 5 each show four logic cells in the basic cell and FIG. 3 and FIG. 6 each show three logic cells in the basic cell, the number of logic cells is not intended to be limited to any particular number. The basic cell structure can be flexibly modified in view of the basic cell area and DROP effect.

As described above, the present invention is characterized in that the arrangement of cells can be optimized in advance for reduction of DROP at the logical synthesis and layout steps for a semiconductor integrated circuit and is more effective in reduction of voltage variation as the miniaturization process is finer.

What is claimed is:

1. One of basic cells in a semiconductor integrated circuit formed by combining a plurality of prepared basic cells, comprising:
one or more logic cells; and
one or a plurality of capacity cells between a power supply line and a ground line which are connected to the logic cells.

2. One of basic cells in a semiconductor integrated circuit formed by combining a plurality of prepared basic cells, wherein:
the basic cell includes a plurality of logic cells; and
the plurality of logic cells are not connected to each other.

3. The basic cell of claim 1, wherein:
the basic cell includes a plurality of logic cells; and
the plurality of logic cells are not connected to each other.

4. The basic cell of claim 1, wherein any one of the power supply line and the ground line which are connected to the logic cells is not shared by an adjacent logic cell.

5. The basic cell of claim 2, wherein any one of the power supply line and the ground line which are connected to the logic cells is not shared by an adjacent logic cell.

6. The basic cell of claim 3, wherein any one of the power supply line and the ground line which are connected to the logic cells is not shared by an adjacent logic cell.

7. The basic cell of claim 1, further comprising a resistive cell on an output signal line of the logic cell.

8. The basic cell of claim 1, further comprising a capacity cell between an output signal line of the basic cell and the ground line.

9. The basic cell of claim 1, further comprising:
a capacity cell between an output signal line of the basic cell and the ground line; and
a resistive cell on the output signal line of the logic cell.

10. The basic cell of claim 1, wherein positions of input and output terminals of the basic cell are different from those of the other basic cells.

11. The basic cell of claim 1, wherein positions of the logic cells of the basic cell are different from those of the other basic cells.

12. The basic cell of claim 1, wherein positions of input and output terminals of the basic cell and positions of the logic cells of the basic cell are different from those of the other basic cells.

13. The basic cell of claim 1, wherein the driving capacity of the logic cell of the basic cell is different from that of the other basic cells.

14. A logic synthesis method, wherein the basic cell of claim 1 is prepared in the form of a logic synthesis cell library in advance in a logic synthesis process in which a layout netlist is generated.

15. A basic cell layout method, wherein a basic cell arrangement process by layout includes:
a basic cell arranging step of arranging the basic cell of claim 1;
a wiring congestion calculating step of calculating a wiring congestion from a result of the basic cell arrangement; and
changing the basic cell to a basic cell having different input and output terminal positions according to the wiring congestion.

16. A basic cell layout method, wherein a process after basic cell arrangement by layout includes:
a basic cell count step of calculating the number of basic cells of claim 1 provided in a basic cell row to which a common power branched from a main power supply is supplied; and
a basic cell arrangement averaging step of averaging the number of basic cells provided in the basic cell row.

17. A basic cell layout method, wherein a process after basic cell arrangement by layout includes:
a first basic cell count step of calculating the number of first basic cells of claim 1 provided in a basic cell row to which a common power branched from a main power supply is supplied;
a basic cell adding step of adding a second basic cell to the basic cell row;
a second basic cell count step of calculating the number of second basic cells; and
a basic cell arrangement averaging step of averaging the number of second basic cells provided in the basic cell row according to the number of first basic cells and the number of second basic cells.

18. A basic cell layout method, wherein a voltage drop analyzing process includes:
a voltage drop determination step of determining a voltage drop amount of a basic cell after arrangement and wiring;
a basic cell changing step of changing the basic cell according to the voltage drop amount; and
an arrangement and wiring step of performing arrangement and wiring processes after the basic cell changing step.
